(19) United States
(12) Patent Application Publication
(10) Pub. No.: US 2015/0066527 A1
(43) Pub. Date: Mar. 5, 2015

(54) SYSTEM AND METHOD FOR ARBITRAGED BASED MEDICAL SERVICES

(71) Applicant: PokitDok, Inc., San Mateo, CA (US)

(72) Inventors: Theodore C. Tanner, San Mateo, CA (US); Douglas C. Thomas, San Mateo, CA (US)

(73) Assignee: PokitDok, Inc.

(21) Appl. No.: 14/328,591

(22) Filed: Jul. 10, 2014

Related U.S. Application Data
(60) Provisional application No. 61/871,195, filed on Aug. 28, 2013.

(51) Int. Cl. G06Q 30/06; G06Q 50/22

(52) U.S. Cl. CPC G06Q 30/06; G06Q 50/22
USPC 705/2

(57) ABSTRACT

A request for quote system and method are described. The system may allow a user to request a quote for healthcare in a geographic region from a practitioner that has a specialty and/or has the expertise to treat a particular disease or condition.

### PRIORITY CLAIMS/RELATED APPLICATIONS

This application claims the benefit under 35 USC 119(e) to U.S. Provisional Patent Application No. 61/871,195, filed Aug. 28, 2013 and entitled “System And Method For Arbitraged Based Medical Services”, the entirety of which is incorporated herein by reference.

### FIELD

The disclosure relates generally to a healthcare system and method and in particular to a system and method for arbitraged based medical services. The request for quote process described below optimizes the arbitrage process in the medical goods and services markets.

### BACKGROUND

Systems exist that create a social marketplace for healthcare. Some of the systems are social marketplaces for patients and some of the systems are for practitioners that allow the practitioner to become a member and reach potential clients. However, these system do not allow a consumer to search for a healthcare practitioner in a particular geographic area to treat a particular condition or disease or who has a desired specialty and request a quote from the practitioner. Thus, it is desirable to provide a system and method that allows a consumer to search for a healthcare practitioner in a particular geographic area to treat a particular condition or disease or who has a desired specialty and request a quote from the practitioner.

### BRIEF DESCRIPTION OF THE DRAWINGS

FIG. 1 is a healthcare marketplace system that may incorporate a request for quote system;

FIG. 2 illustrates details of an embodiment of the request for quote system;

FIG. 3 illustrates a method for requesting a quote;

FIGS. 4 and 5 illustrate an example of a healthcare search user interface of the request for quote system;

FIG. 6 illustrates an example of a practitioner details user interface of the request for quote system;

FIG. 7 illustrates an example of a request for quote user interface of the request for quote system;

FIG. 8 illustrates an example of a practitioner user interface of the request for quote system;

FIG. 9 illustrates an example of an internal practioner user interface of the request for quote system;

FIG. 10 illustrates an example of a user quote details user interface of the request for quote system;

FIG. 11 illustrates an example of a user quote summary user interface of the request for quote system;

FIG. 12 illustrates an example of a user quote user interface of the request for quote system;

FIG. 13 illustrates an example of a create for quote user interface of the request for quote system;

FIG. 14 illustrates an example of a user pending quote user interface of the request for quote system;

FIG. 15 illustrates an example of a practitioner quote user interface of the request for quote system;

FIG. 16 illustrates an example of a user accepted quote user interface of the request for quote system;

FIG. 17 illustrates an example of a practitioner open requests user interface of the request for quote system; and

FIG. 18 illustrates an example of a practitioner accepted quotes user interface of the request for quote system.

### DETAILED DESCRIPTION OF ONE OR MORE EMBODIMENTS

The disclosure is particularly applicable to a mobile application based healthcare request for quote system that interfaces with a cloud computing based backend system and it is in this context that the disclosure will be described. It will be appreciated, however, that the system and method has greater utility since the system may be used with industries other than healthcare and may be implemented in other manners that are within the scope of the disclosure. In addition, the request for quote system may be a standalone system. The request for quote process described below optimizes the arbitrage process in the medical goods and services markets.

The healthcare request for quote system and method may be part of a healthcare social marketplace that allows practitioners that have joined the healthcare social community to reach potential clients in ways unimaginable even a few years ago. In addition to giving practitioners a social portal with which to communicate and market themselves with consumers, the marketplace gives each healthcare practitioner the ability to offer their services in an environment that is familiar to users of Groupon, Living Social, or other social marketplaces. But unlike these other social marketplaces, individual practitioners or practices in the social community can offer their full inventory of services, either at their regular cash price or at a discount.

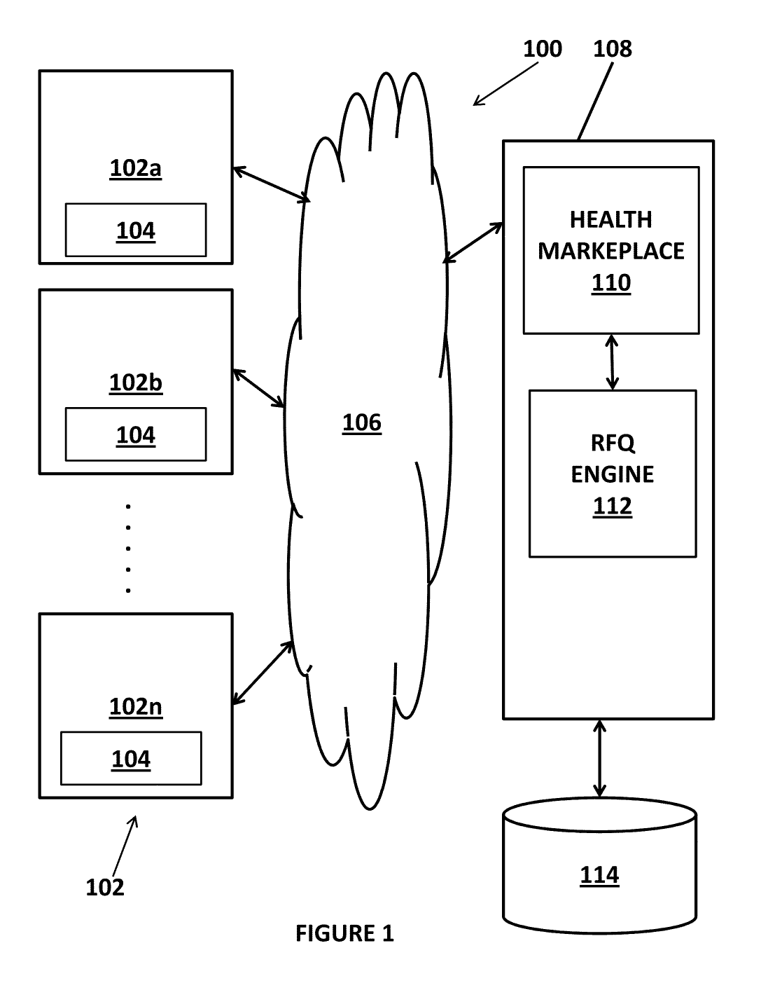

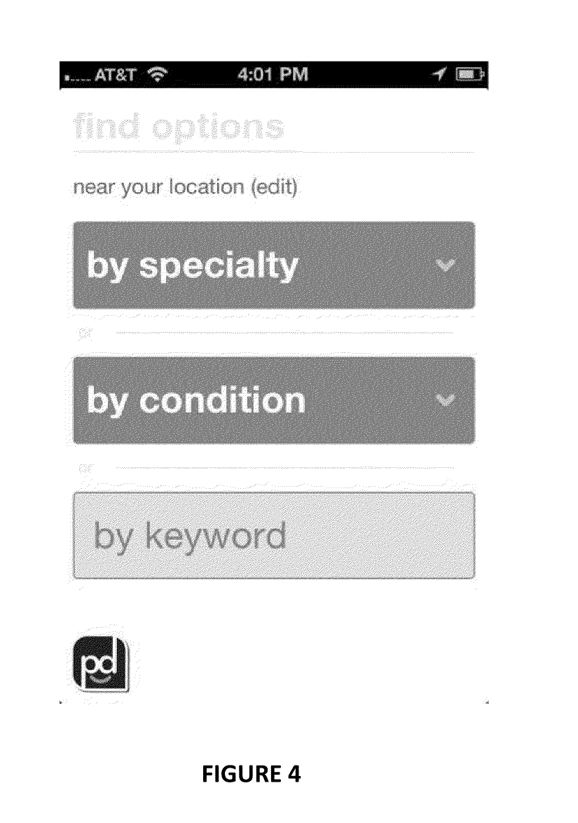

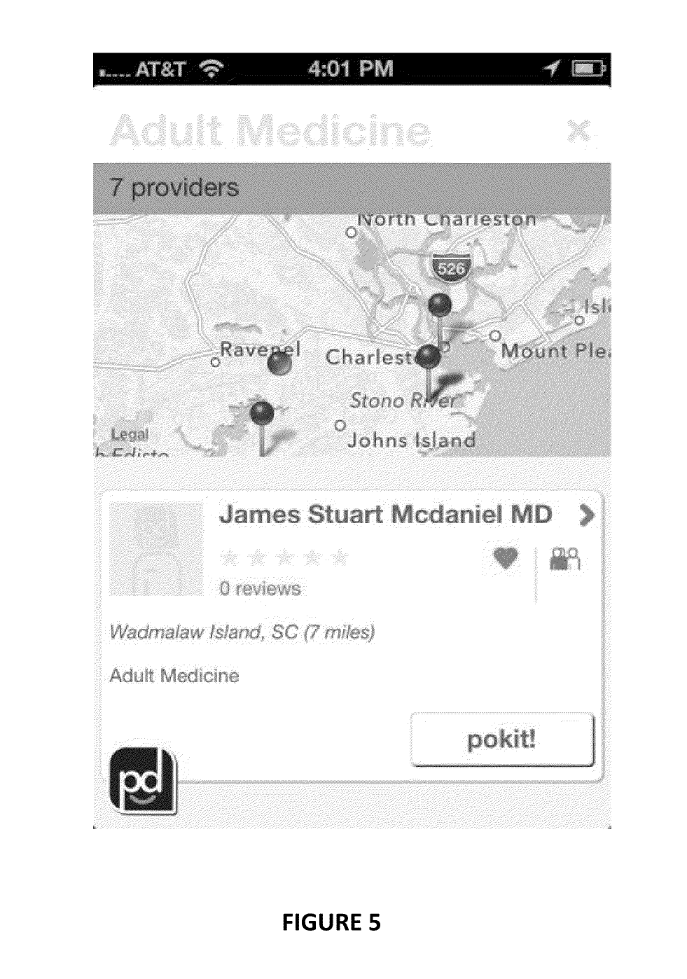

FIG. 1 is a healthcare marketplace system 100 that may incorporate a request for quote system. The healthcare marketplace system 100 may have one or more computing devices 102 that connect over a communication path 106 to a backend system 108. Each computing device 102, such as computing devices 102a, 102b, . . . , 102n as shown in FIG. 1, may be a processor based device with memory, persistent storage, wired or wireless communication circuits and a display that allows each computing device to connect to and couple over the communication path 106 to a backend system 108. For example, each computing device may be a smartphone device, such as an Apple Computer product, Android OS based product, etc., a tablet computer, a personal computer, a terminal device, a laptop computer and the like. In one embodiment shown in FIG. 1, each computing device 102 may store an application 104 in memory and then execute that application using the processor of the computing device to interface with the backend system. For example, the application may be a typical browser application or may be a mobile application, such as is shown in the example user interfaces in FIGS. 4-7. The application 104 may have a user interface component that allows the user to input request for quote information as shown in FIGS. 5-7 and to view the one or more quotes received from each practitioner in response to the request for quote. The communication path 106 may be a wired or wireless communication path that uses a secure protocol or an unsecure protocol. For example, the communication path 106 may be the Internet, Ethernet, a wireless data network, a cellular digital data network, a WiFi network and the like.

The backend system 108 may also have a health marketplace engine 110 and a request for quote engine 112 that may be coupled together. Each of these components of the backend system may be implemented using one or more computing resources, such as one or more server computers, one or more cloud computing resources and the like. In one embodiment, the health marketplace engine 110 and the request for quote engine 112 may each be implemented in software in which each has a plurality of lines of computer code that are executed by a processor of the one or more computing resources of the backend system. In other embodiments, each of the health marketplace engine 110 and the request for quote engine 112 may be implemented in hardware such as a programmed logic device, a programmed processor or microcontroller and the like. The backend system 108 may be coupled to a store 114 that stores the various data and software modules that make up the healthcare system. The store 114 may be implemented as a hardware database system, a software database system or any other storage system.

The health marketplace engine 110 may allow practitioners that have joined the healthcare social community to reach potential clients in ways unimaginable even a few years ago. In addition to giving practitioners a social portal with which to communicate and market themselves with consumers, the marketplace gives each healthcare practitioner the ability to offer their services in an environment that is familiar to users of Groupon, Living Social, or other social marketplaces.

The request for quote engine 112, in the example shown in FIG. 1 in which the request for quote engine 112 is part of the health marketplace system 110, allows a user of the health marketplace system to search for practitioners in their area that treat their conditions or practice in a desired specialty and request a quote for the medical service they need. Furthermore, the user may request quotes from more than one practitioner for the same desired specialty, disease and/or condition to create a competitive environment when the user/consumer can choose the quote that best meets their selection criteria.

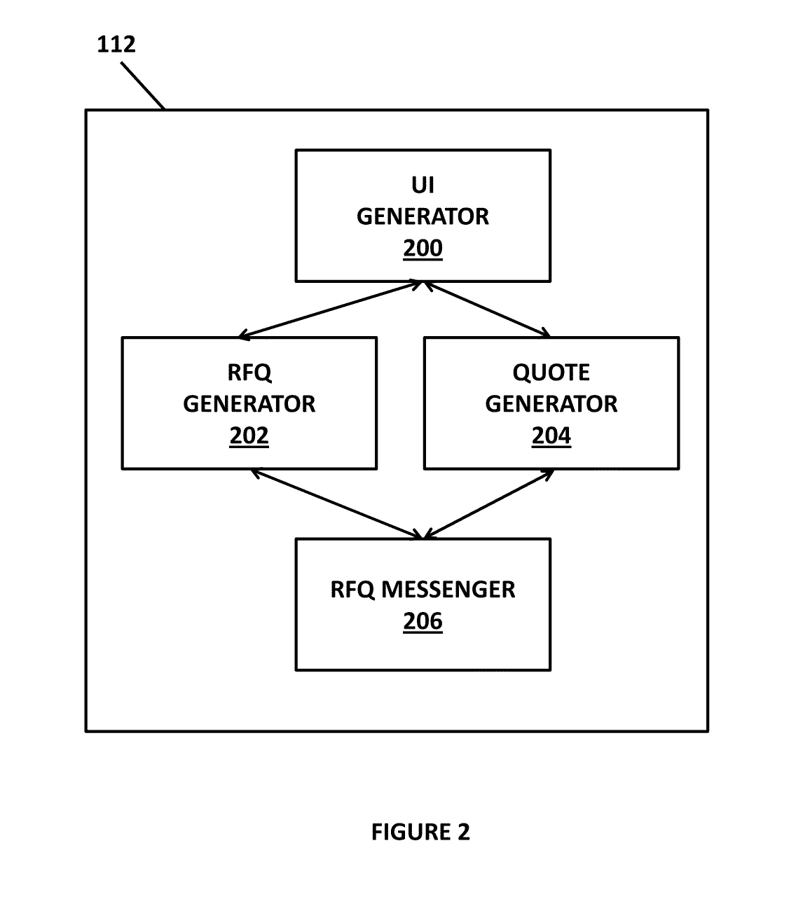

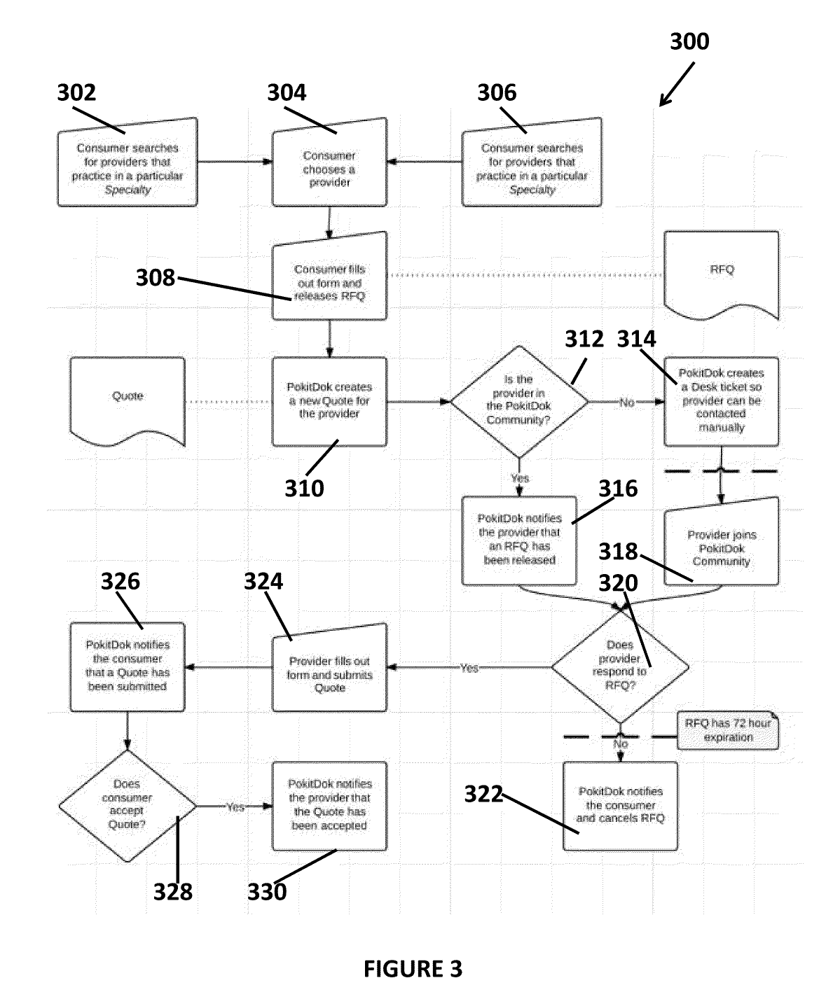

FIG. 2 illustrates details of an embodiment of the request for quote system 112 that may have a user interface generator 200, an request for quote (RFQ) generator 202, a quote generator 204 and a messenger unit 206 that are coupled to each other. The components of the request for quote system 112 may each be implemented in hardware, software or a combination of hardware and software. More specifically, each component of the request for quote system 112 may be implemented in a microprocessor, a microcontroller, a programmable logic device, a state machine, a plurality of lines of computer code that may be executed by a processor or microprocessor, a microcontroller or a programmable logic device that executes a plurality of lines of computer code (collectively a processor configured to perform the processes shown in FIG. 3.) The user interface generator 200 may generate the data for the user interfaces of the request for quote system (examples of which are shown in FIGS. 4-7 for the user/consumer side), the RFQ generator 202 may generate a request for quote based on a user's request (described below in more detail), the quote generator 204 may generate the quote and quote response for the practitioner and the messenger unit 206 coordinates the communication of the request for quote, quote, etc. of the request for quote system between the one or more practitioners and the consumer who is looking for a practitioner, in a geographic region, with the desired specialty or expertise to treat a condition or disease.

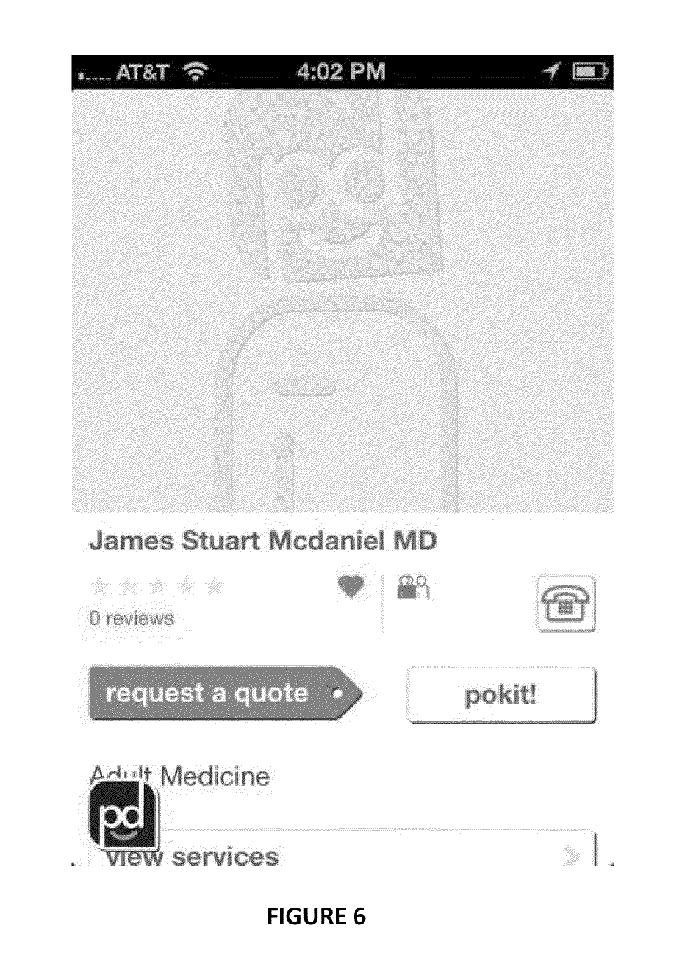

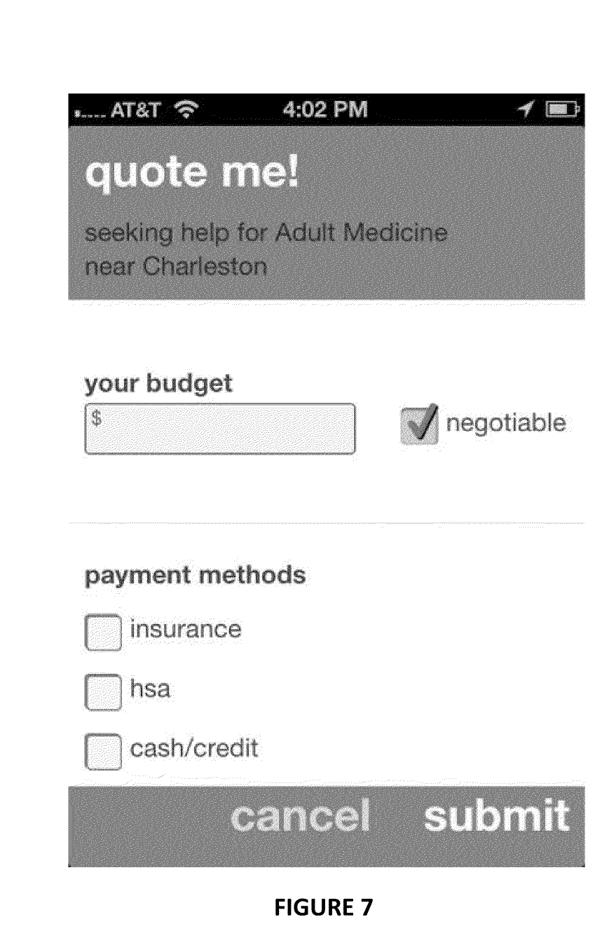

FIG. 3 illustrates a method 300 for requesting a quote that may be implemented, for example, using the components of the request for quote system 112. The method also may be implemented using other components that can perform the processes shown in FIG. 3 and described below. In the method, each user/consumer may search for a practitioner/provider that has a practice with a particular specialty in a geographic area 302, 306 such as by using the user interface shown in FIG. 4 that allows the user to search, in the geographic area of the user, by healthcare specialty, by condition/disease and/or by keyword. Then user then chooses a provider (304) and fills out a form (308) such as by using the exemplary interfaces shown in FIGS. 5-7. FIG. 5 show a number of providers for adult medicine in geographic area (represented by the pins in the user interface example in FIG. 5) and the details for one of the providers. FIG. 6 shows an example of a user interface that allows the user to request a quote from the practitioner. FIG. 7 is an example of a user interface in which the user can fill out relevant request for quote information, such as a budget, whether the budget is negotiable and payment methods in the example in FIG. 7, so that system may generate a request for quote to the selected practitioner. The method may also allow the user/consumer to request a quote from more than one practitioner.

For each request for quote of the user, the system may generate a request for quote for the provider 310 when the system receives the relevant request for quote information. Each request for quote may have a limited period of acceptance time in which the practitioner can accept or reject the RFQ. In one example, the system may have a 72 hour expiration for each RFQ. The system then may then determine if the practitioner is a member of the health marketplace 312. If the selected practitioner is not a member of the health marketplace 312, the system may be contacted to join the system 314 so that the practitioner joins the system 318 and then receives the RFQ from the system. Returning to process 312, if the selected practitioner is a member of the health marketplace, the system notifies the practitioner/provider that an RFQ has been released 316.

The system, using the messenger unit, determines if the provider responds to the RFQ 320. If the provider does not respond to the RFQ, then the system notifies the user and cancels that RFQ 322. If the provider responds to the RFQ, then the provider fills out a form a submits a quote 324 through the quote component of the system. The system may then notify the user, using the messenger unit, that a quote has been submitted by the particular practitioner 326. Once the user is notified of the quote from the practitioner, the system determines if the user accepts the quote 328. If the user accepts the quote, then the provider is notified of the acceptance using the messenger unit for example 330.

In an embodiment in which the system may generate multiple quotes for the user, the method may involve: 1) the creation and release of a new RFQ; 2) submission of the quote; and 3) the acceptance of the quote.

### Create and Release a New RFQ

The list of practitioners to whom to release the RFQ is passed in from the front end and is used to create the individual quotes by the RFQ generator of the system for example. These Quotes are started off with a New status and remain this way until the practitioner takes action or the RFQ expires, whichever comes first.

There are two ways that quotes can be related to one another. In a bulk quoting scenario, each of the Quotes share a common parent RFQ. In this scenario, the practitioner list has multiple elements. Quotes can also be related to one another if their respective RFQs were released by the same consumer and have the same current_category attribute (meaning they were grouped in the same search results). Therefore, when an RFQ is released, a check needs to occur to see if there are related Quotes in play and if so, the competitor list for each of the RFQs in play needs to be updated to the aggregate set of all practitioners that received an RFQ. As before, a desk ticket gets created if the practitioner in question is unverified while verified practitioners, on the other hand get notified via the normal mechanisms (email, SMS, in-app notification). Future events to send out reminders and the processing of the closing of the bidding window for the RFQ are staged at the appropriate time, based upon the expiration date.

### Submit a Quote

Notify the consumer that a practitioner has provided a quote for services. Future events to send out reminders and the processing of the Quote expiration are staged at the appropriate time, based upon the expiration date.

### Accepting a Quote

All of the other related quotes need to be implicitly rejected. Notify the practitioner externally that the quote has been accepted by the consumer. Notify the consumer what the next steps are next.

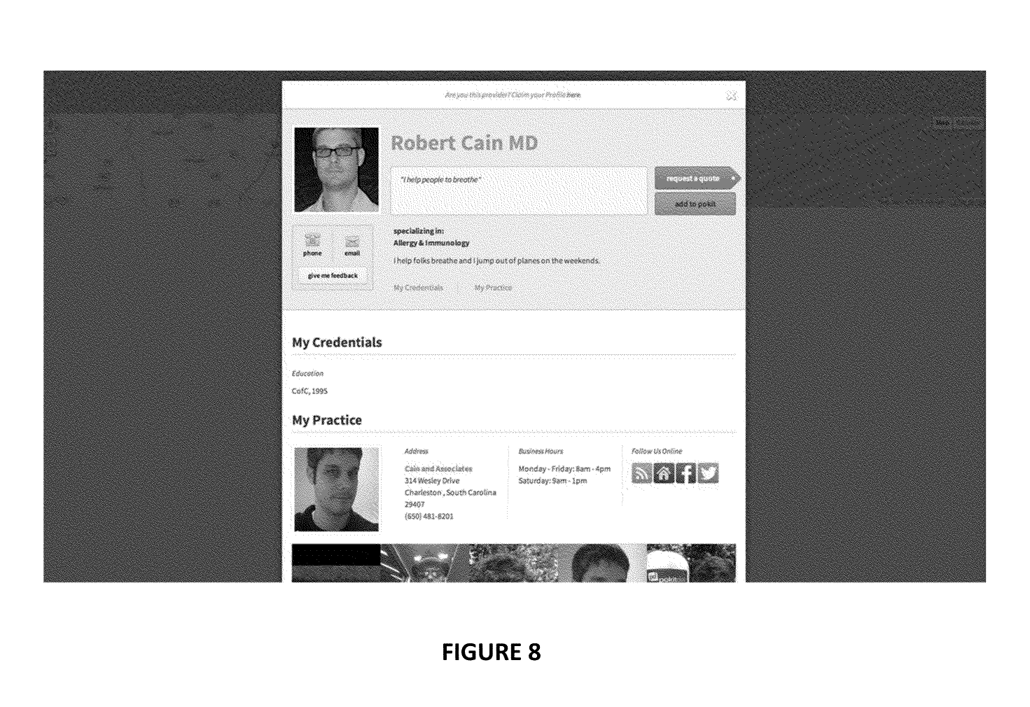

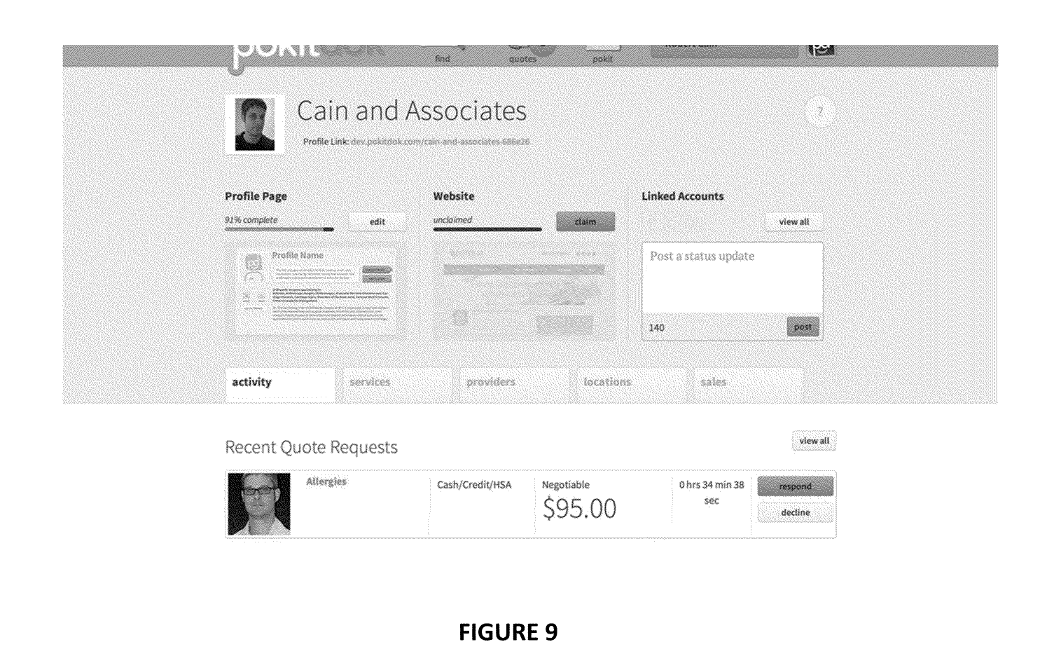

FIG. 8 illustrates an example of a practitioner user interface of the request for quote system in which a practioner may post information about his services and expertise that may be viewed by a user of the system. The user interface may also have a user interface element to request a quote by a user for the service. FIG. 9 illustrates an example of an internal practioner user interface of the request for quote system that allows the practitioner who is part of the health system to view his attributes of the system such as the profile page, website, linked accounts as well as recent quote requests as shown. In this user interface in FIG. 9, the practitioner can respond and/or decline a user quote using the “respond” and “decline” buttons that are associated with each quote request.

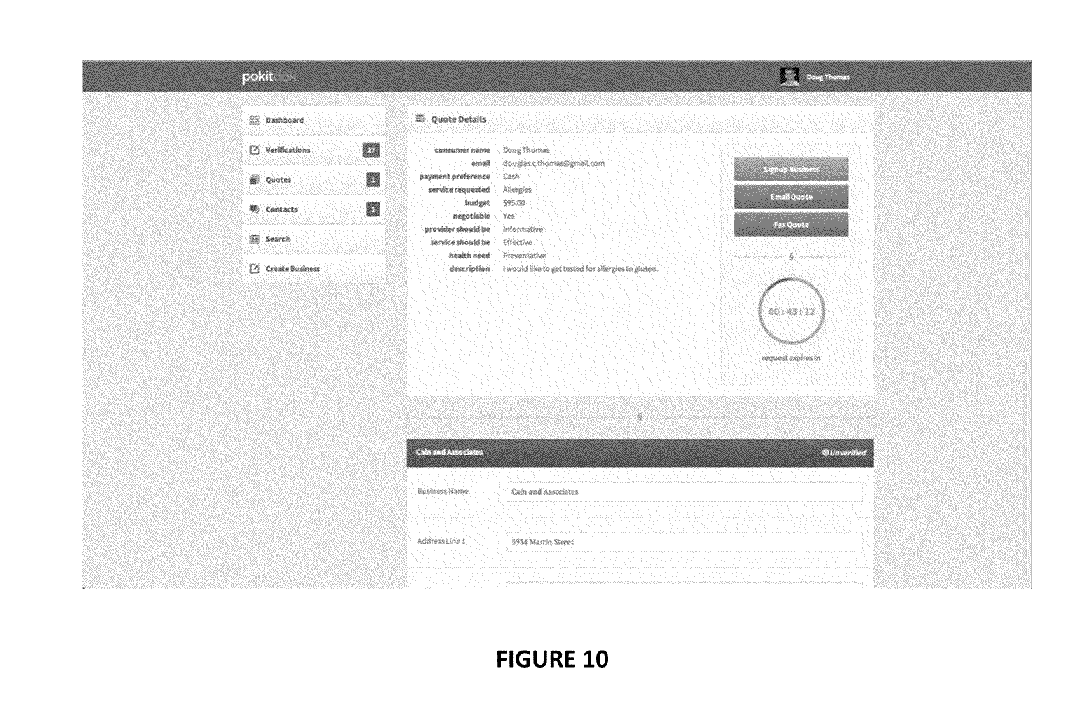

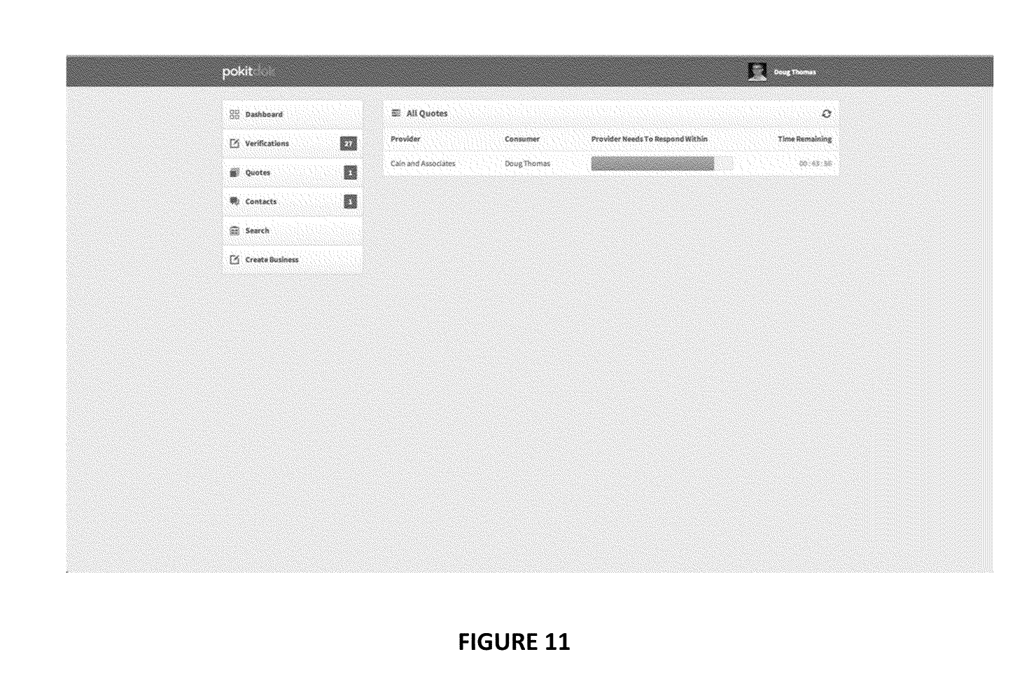

FIG. 10 illustrates an example of a user quote details user interface of the request for quote system. The user interface allows a user to view a set of details of a quote request including a request expiration time for the particular request. FIG. 11 illustrates an example of a user quote summary user interface of the request for quote system that shows a summary of each of the quotes made by a user. The user interface also may have an indication of the time remaining for the quote.

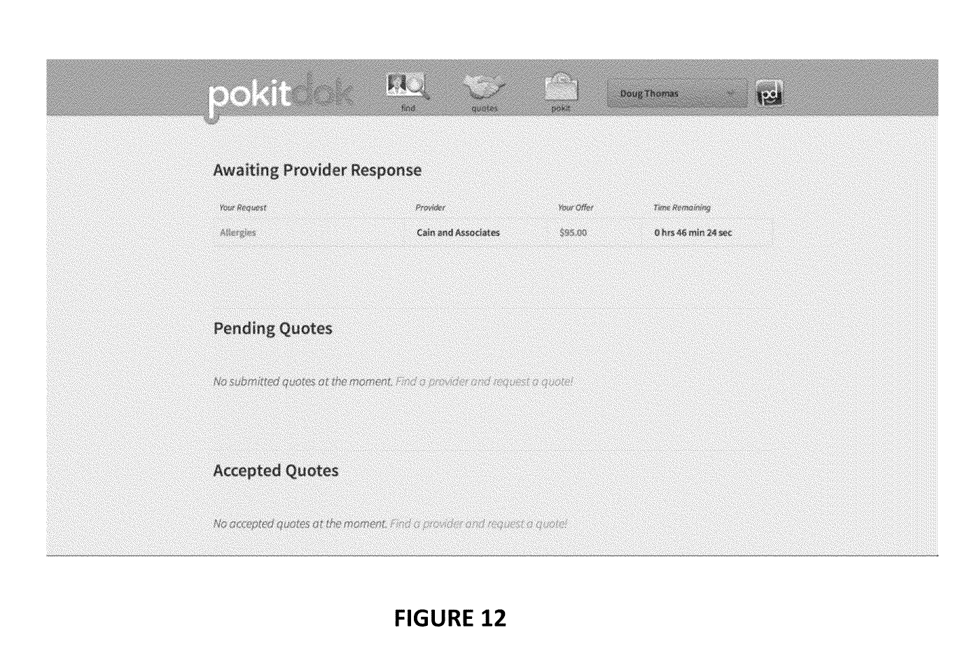

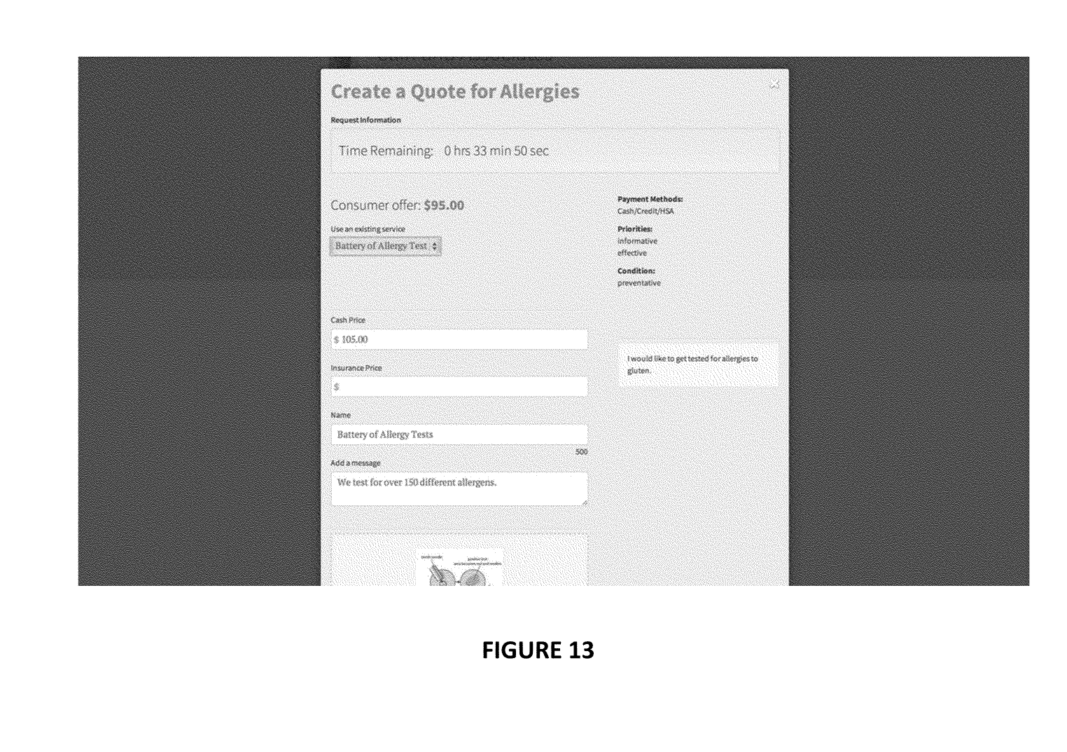

FIG. 12 illustrates an example of a user quote user interface of the request for quote system in which the quotes awaiting for a provider/practitioner response, pending quotes and accepted quotes for the user are shown. In the example in FIG. 12, a request for quote for an allergy test at $95.00 is shown. FIG. 13 illustrates an example of a create for quote user interface of the request for quote system that allows the practitioner/provider to create a quote based on a request for quote from a user. In the example in FIG. 13, the practitioner/provider is quoting $105.00 cash price instead of the $95.00 user/consumer offer.

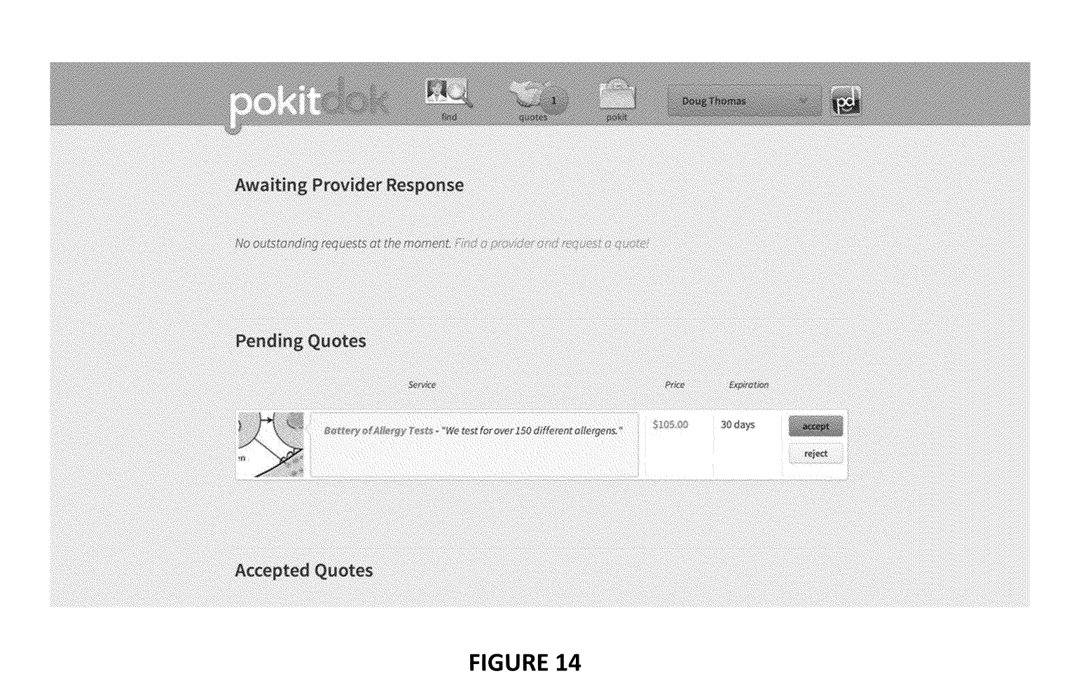

FIG. 14 illustrates an example of a user pending quote user interface of the request for quote system in which the user can view quotes awaiting provider responses, pending quotes and accepted quotes. In this example, the pending quote of $105 cash for an allergy test is shown. The user interface also may have a user interface element to accept or reject the provider's quote.

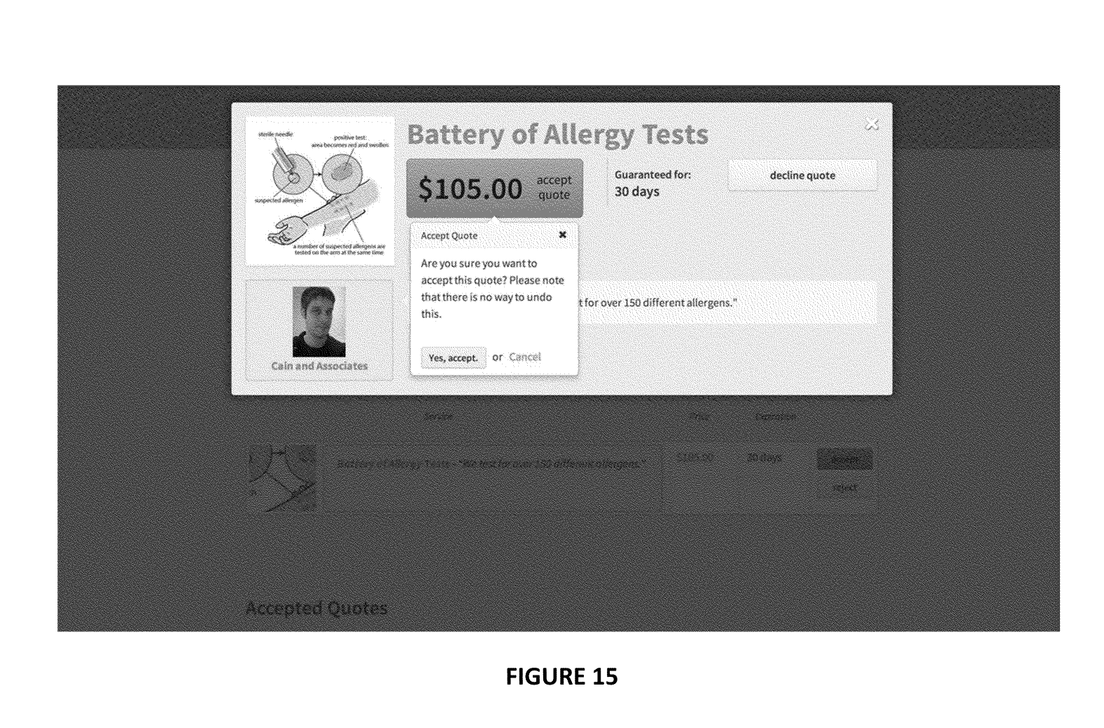

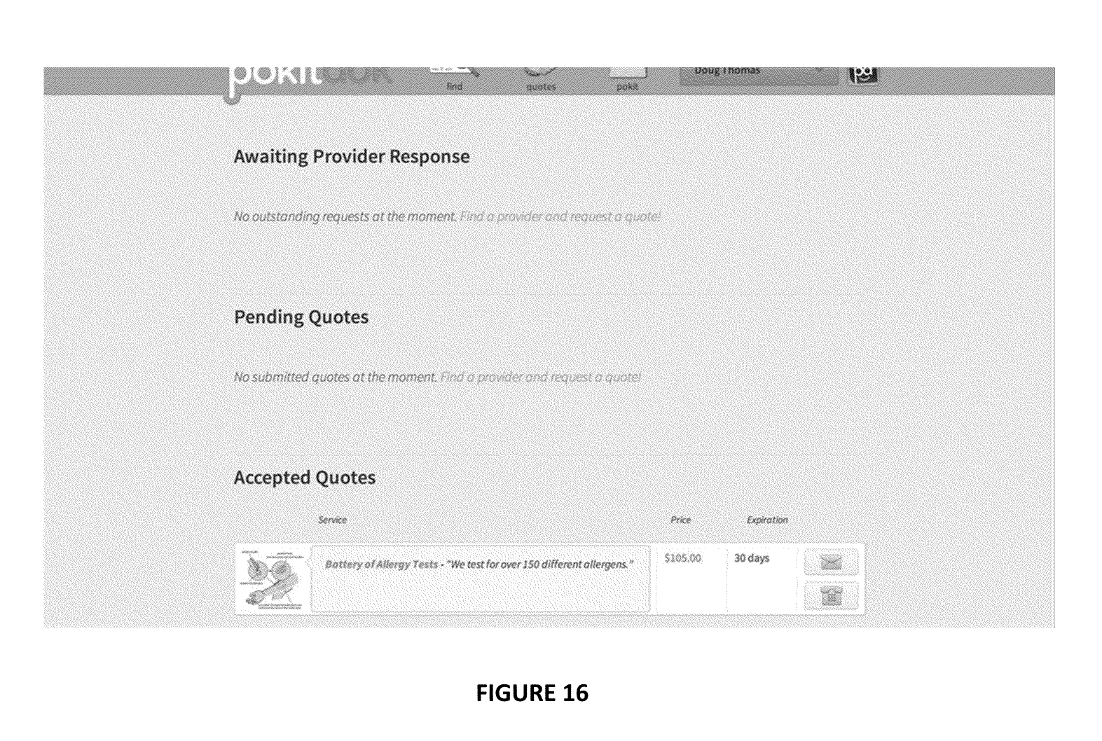

FIG. 15 illustrates an example of a practitioner quote user interface of the request for quote system that is displayed to the user/consumer when the user selects the accept quote button in FIG. 14 who can then accept the quote. Once the user accepts the quote, FIG. 16 illustrates an example of a user accepted quote user interface of the request for quote system in which the accepted quote is now in the accepted quotes section of the user interface. The accepted quotes user interface may also show the expiration date of the quote.

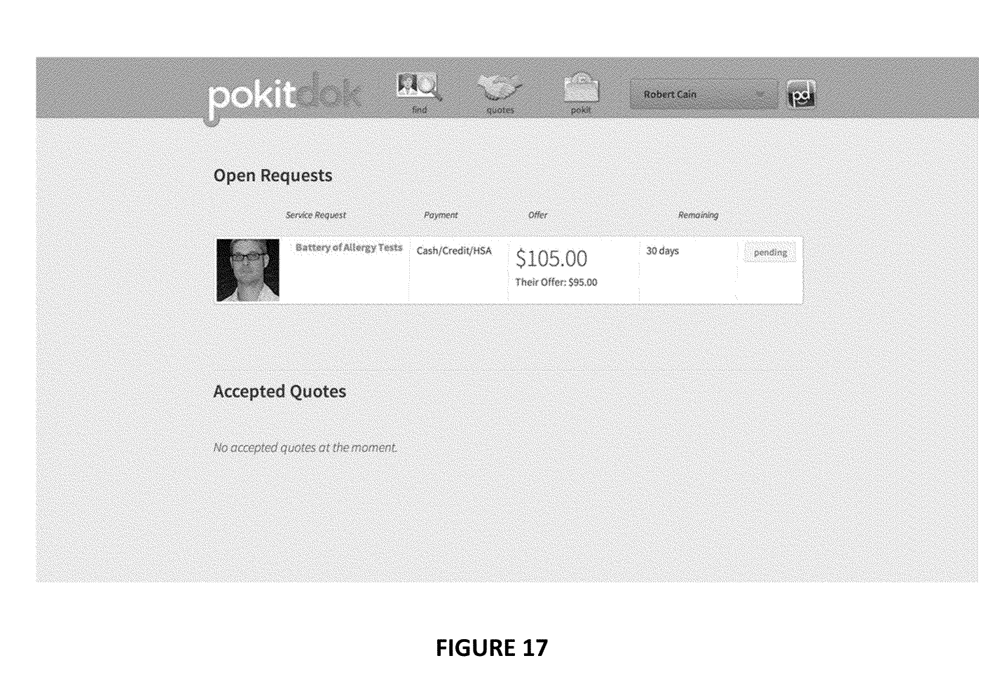

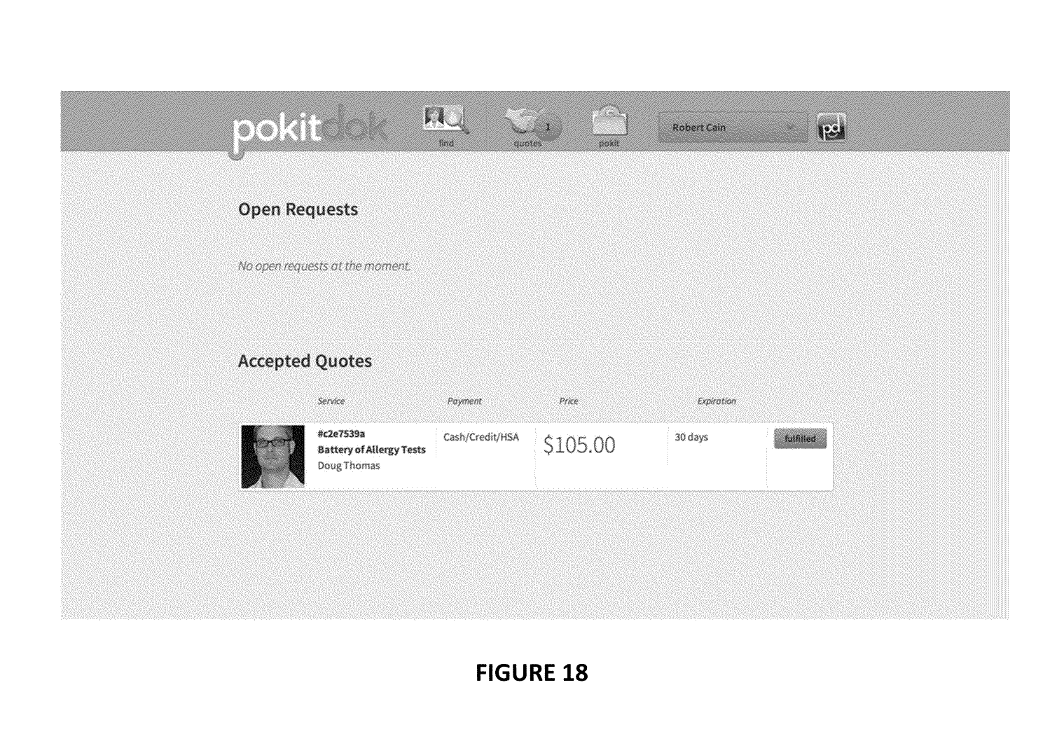

FIG. 17 illustrates an example of a practitioner open requests user interface of the request for quote system in which a particular practitioner/provider may view any open requests such as those shown in FIG. 17. FIG. 18 illustrates an example of a practitioner accepted quotes user interface of the request for quote system.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A request for quote apparatus, comprising:
a medical backend component; and
the medical backend component having a request for quote component, the request for quote component having a processor that is configured to receive a request for quote for a medical service, the request for quote for a medical service including one or more practitioners, a budget for the medical service and a payment method for the requested medical service, to communicate a request for quote to the one or more practitioners based on the request for quote for a medical service, to determine if the one or more practitioners respond to the request for quote with a quote and to communicate, if a practitioner responds to the request for quote, the quote to an entity that requested the request for quote for a medical service.

2. The apparatus of claim 1, wherein the processor is configured to determine if the entity accepts the quote from the practitioner.

3. The apparatus of claim 1, wherein the processor is configured to determine if the one or more practitioner provided a new budget as part of the quote.

4. The apparatus of claim 1, wherein the processor is configured to cause the request for quote to expire if the one or more practitioners do not respond within an expiration period.

5. The apparatus of claim 4, wherein the expiration period is 72 hours.

6. The apparatus of claim 1, wherein the processor is configured to communicate the request for quote to a plurality of practitioners.

7. The apparatus of claim 1, wherein the request for quote for a medical service includes a negotiable budget.

8. A method comprising:
receiving, by a medical request for quote system, a request for quote for a medical service, the request for quote for a medical service including one or more practitioners, a budget for the medical service and a payment method for the requested medical service;
communicating a request for quote to the one or more practitioners based on the request for quote for a medical service;
determining if the one or more practitioners respond to the request for quote with a quote; and
communicating, if a practitioner responds to the request for quote, the quote to an entity that requested the request for quote for a medical service.

9. The method of claim 8 further comprising determining if the entity accepts the quote from the practitioner.

10. The method of claim 8, wherein determining if the one or more practitioners respond to the request for quote with a quote further comprises determining if the one or more practitioner provided a new budget as part of the quote.

11. The method of claim 8 further comprising causing the request for quote to expire if the one or more practitioners do not respond within an expiration period.

12. The method of claim 11, wherein the expiration period is 72 hours.

13. The method of claim 8, wherein communicating the request for quote further comprising communicating the request for quote to a plurality of practitioners.

14. The method of claim 8, wherein the request for quote for a medical service includes a negotiable budget.

15. A system, comprising:
a medical system having a a processor and a request for quote component;
one or more computing devices that are each configured to couple to and communicate with the request for quote component;
each computing device having a processor configured to generate a request for quote for a medical service, the request for quote for a medical service including one or more practitioners, a budget for the medical service and a payment method for the requested medical service and to communicate the request for quote for a medical service to the request for quote component; and
the request for quote component having a processor configured to communicate a request for quote to the one or more practitioners based on the request for quote for a medical service, to determine if the one or more practitioners respond to the request for quote with a quote and to communicate, if a practitioner responds to the request for quote, the quote to an entity that requested the request for quote for a medical service.

16. The system of claim 15, wherein the processor of the request for quote is configured to determine if the entity accepts the quote from the practitioner.

17. The system of claim 15, wherein the processor of the request for quote is configured to determine if the one or more practitioner provided a new budget as part of the quote.

18. The system of claim 15, wherein the processor of the request for quote is configured to cause the request for quote to expire if the one or more practitioners do not respond within an expiration period.

19. The system of claim 18, wherein the expiration period is 72 hours.

20. The system of claim 15, wherein the processor of the request for quote is configured to communicate the request for quote to a plurality of practitioners.

21. The system of claim 15, wherein the request for quote for a medical service includes a negotiable budget.

22. The system of claim 15, wherein each computing device has an application that interfaces with the request for quote component.

23. The system of claim 22, wherein the application is one of a browser application and a mobile application.

24. The system of claim 22, wherein the application has a user interface component that permits entry of the request for quote information and displays the quote from the one or more practitioners.
